(19) United States
(12) Patent Application Publication
(10) Pub. No.: US 2023/0387729 A1
(43) Pub. Date: Nov. 30, 2023

(54) POWER MANAGEMENT AND DISTRIBUTION

(71) Applicant: Meta Platforms Technologies, LLC, Menlo Park, CA (US)

(72) Inventors: Sachin Ramesh Chandra, Woodinville, WA (US); Ankur Gupta, Redwood City, CA (US)

(21) Appl. No.: 17/824,849

(22) Filed: May 25, 2022

(51) Int. Cl. H02J 50/80; H02J 50/40; H02J 7/00; H02J 7/34; G02B 27/01; G06F 1/3218

(52) U.S. Cl. CPC H02J 50/80; H02J 50/40; H02J 7/00034; H02J 7/342; G02B 27/017; G06F 1/3218

(57) ABSTRACT

A system for managing power distribution among devices based on one or more applicable power policies. The system can receive state data, including power condition data representing power conditions associated with a plurality of devices including a first device. The system can determine, based on the power condition data, a second device to wirelessly provide power to the first device. The system can generate a power distribution command configured to cause wireless power transmission from the second device to the first device and send the power distribution command to at least one of the first device or the second device to initiate wireless power transmission from the second device to the first device.

### FIELD OF THE INVENTION

The present disclosure generally relates to power management and distribution, and specifically relates to managing power distribution among electronic devices based on one or more power policies.

### BACKGROUND

Recent years have seen significant advancements in hardware and software platforms for generating and providing extended reality experiences. Indeed, electronic devices for providing extended reality (e.g., virtual reality, augmented reality, mixed reality, etc.) have grown in popularity, and technological advancements have facilitated its use in a variety of applications, such as gaming, online shopping, military training, and tourism. These electronic devices may consume a significant amount of power and typically have limited space for the placement of battery components, which leads to reduced runtimes. In some instances, conventional electronic devices enable users to charge the devices via a power outlet or a charging dock. However, such an approach may interrupt user activities and reduce the overall customer experience.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques for managing power distribution among electronic devices based on one or more power policies.

FIG. 2 is a perspective view of an example apparatus, implemented as an eyewear device, configured to manage power distribution among electronic devices based on one or more power policies, in accordance with one or more examples.

FIG. 3 is a perspective view of an example apparatus, implemented as a head-mounted display (HMD), configured to manage power distribution among electronic devices based on one or more power policies, in accordance with one or more examples.

FIG. 4 is a flowchart of an example process for managing power distribution among electronic devices based on one or more power policies, in accordance with one or more examples.

FIGS. 5A-5F are flowcharts of example processes for managing power distribution among electronic devices based on one or more power policies, in accordance with one or more examples.

FIG. 6 is an example system for managing power distribution among electronic devices based on one or more power policies, in accordance with one or more examples.

### DETAILED DESCRIPTION

Conventional electronic devices may enable users to charge electronic devices via a power outlet or a charging dock. However, such an approach may interrupt user activities and reduce the overall customer experience. For example, a user of a conventional wearable device (e.g., a virtual reality headset) may experience low battery while the user engaging in an activity (e.g., gaming, video conferencing, etc.) and may have to interrupt the activity to charge the wearable device, which can result in poor user experience. Thus, the described techniques provide functionality beyond what is provided in conventional electronic devices by wirelessly charging an electronic device in a system with power coming from one or more electronic devices in the same system.

A system for managing power distribution among electronic devices based on one or more power policies is described herein. The system may receive state data representing a current state of the electronic devices in the system. The state data may include power condition data representing power conditions associated with electronic devices, such as a state of charge of the various electronic devices in the system. The charge state may include, for example, a quantity of charge remaining for each device (e.g., number of amp hours remaining), or a percentage of charge remaining for each device (e.g., 90% of full charge. In some examples, the system may determine, based on the power condition data, a first device to wirelessly receive power from one or more of the electronic devices. In other examples, the first device that is to receive power from one or more of the other electronic devices may be determined in advance (e.g., a primary, predetermined or default device, the charge state of which is to be maintained at the expense of other devices in the system). In either case, the system may determine a second device to wirelessly provide power to the first device based at least in part on the power condition data. The system may then generate a power distribution command to cause wireless power transmission from the second device to the first device and send the power distribution command to the first device and/or the second device to initiate wireless power transmission from the second device to the first device.

In some examples, the state data additionally or alternatively includes location data representing a location of the electronic devices in a three-dimensional coordinate frame, relative to a point of reference in the environment, and/or a distance of the device relative to one or more other devices in the system. The system may determine, based at least in part on the location data, a relative ability (e.g., efficiency) of the various electronic devices to wirelessly charge one another. For instance, devices that are closer together may be able to more efficiency wirelessly charge one another than device that are further apart. The system may further determine, based on the location data, the second device to wirelessly provide power to the first device.

In some examples, the state data additionally or alternatively includes an indication of a running application associated with the electronic devices. The system may determine, based at least in part on the running application, an importance rank of the electronic devices. The system may further determine, based on the power condition data and the importance rank, the second device to wirelessly provide power to the first device.

In some examples, the state data additionally or alternatively includes a current or predicted activity level associated with the electronic devices. The system may determine, based on the current or predicted activity level associated with the plurality of devices, an importance rank of the electronic devices. The system may further determine, based on the power condition data and the importance rank, the second device to wirelessly provide power to the first device.

In some examples, the state data additionally or alternatively includes importance scores associated with the electronic devices. The system may determine, based on the power condition data and the plurality of importance scores, the second device to wirelessly provide power to the first device.

In some examples, the state data additionally or alternatively includes a number of charge cycles associated with the electronic devices. The system may determine, based on the power condition data and the number of charge cycles, the second device to wirelessly provide power to the first device. For instance, the system may prioritize using a device with fewer charge cycles to charge the first device.

In some examples, the state data additionally or alternatively includes a dominant hand preference associated with a user indicating whether the user favors right-handed use or left-handed use. The system may determine, based on the power condition data and the dominant hand preference, the second device to wirelessly provide power to the first device.

In some examples, the system may determine a charge imbalance between the first device and an electronic device based on the power condition data. The system may further determine, based on the power condition data and the charge imbalance, the second device to wirelessly provide power to the first device.

In some examples, the power distribution command is generated and sent by the second device to the first device to cause the second device to wirelessly charge the first device.

In some examples, the system includes a head-mounted device. The head-mounted device may include a wireless power transmission component and a networking component. The wireless power transmission may send or receive power wirelessly to or from one or more electronic devices. The networking component may send or receive data wirelessly to or from the electronic devices.

Accordingly, techniques such as wirelessly distributing power based on power policies can be employed, which can monitor the states of electronic devices and manage power distribution among the electronic devices as needed based on applicable power policies. For example, one or more devices in the system can store a plurality of power policies which define how and under what conditions one or more devices of the system should be wirelessly charged by one or more other devices in the system. In some examples, the system may monitor state data of the various electronic devices in the system and determine which power policy (or policies) to apply based on the state data associated with the electronic devices. By managing power distribution among the electronic devices based on applicable power policies, the techniques described herein increase active runtimes of the electronic devices and improve user experience. Examples of electronic devices include, but are not limited to, wearable devices (e.g., eyewear devices, glasses, headsets, helmets, earphones, ear buds, hearing aids, watches, fitness trackers, rings, etc.), mobile devices (e.g., phones, tablets, etc.), charging cases or stations, video game systems or controllers, and/or other portable or stationary electronic devices.

Examples of the present disclosure can include or be implemented in conjunction with an extended reality system. Extended reality is a form of reality that has been adjusted in some manner before presentation to a user, which can include, e.g., a virtual reality (VR), an augmented reality (AR), a mixed reality (MR), a hybrid reality, or some combination and/or derivatives thereof. Extended reality content can include completely computer-generated content or computer-generated content overlaid or otherwise combined with real-world content. In some examples, the real-world content may be perceived by a user directly (e.g., through a transparent or translucent lens), while in other examples the real-world content may be captured by one or more cameras or other sensors and then displayed via a display screen or projected on to a surface for perception by the user. The extended reality content can include video, audio, haptic feedback, or some combination thereof, and any of which can be presented in a single channel or in multiple channels (such as stereo video that produces a three-dimensional effect to the viewer). Additionally, in some examples, extended reality can also be associated with applications, products, accessories, services, or some combination thereof, that are used to, e.g., create content in an extended reality and/or are otherwise used in (e.g., to perform activities in) an extended reality environment. The extended reality system that provides the extended reality content can be implemented on various platforms, including a headset (e.g., head-mounted display (HMD) and/or near-eye display (NED)) connected to a host computer system, a standalone headset, a mobile device or electronic device or system, or any other hardware platform capable of providing extended reality content to one or more viewers.

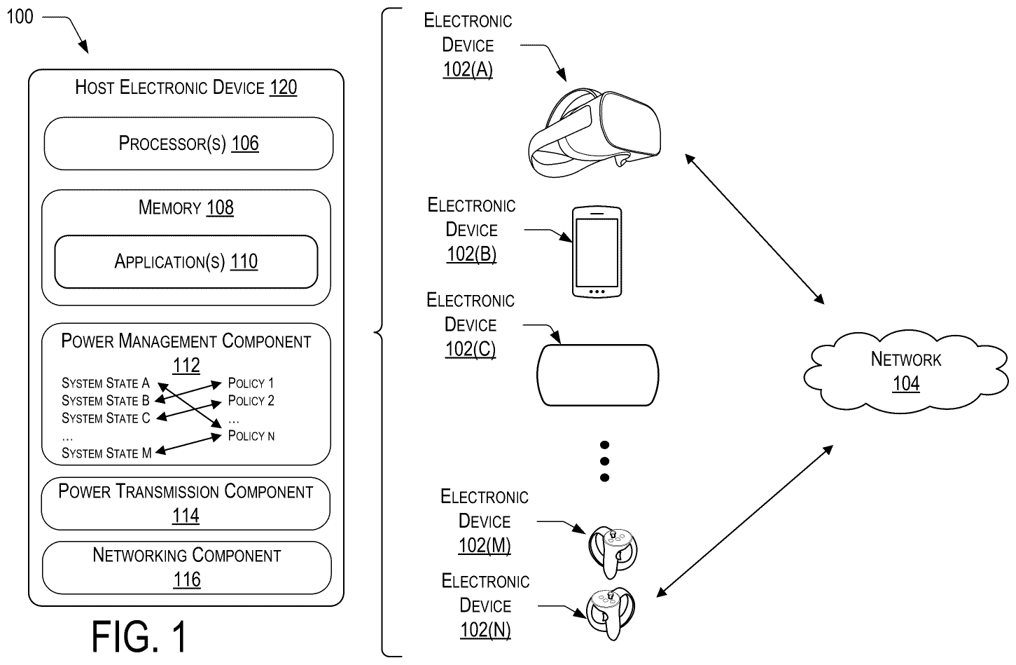

FIG. 1 is a schematic view of an example system 100 usable to implement example techniques for managing power distribution among one or more electronic device(s) 102 based on one or more power policies. As illustrated in FIG. 1, the system 100 may include electronic devices 102(A), 102(B), 102(C) . . . 102(M), and 102(N) (collectively “electronic devices 102”), network 104, and a host electronic device 120. In this example, A and N are non-zero integers greater than or equal to 1.

In some examples, the host electronic device 120 may include one of the electronic devices 102. The electronic devices 102 are communicatively coupled to one another via the network 104. The network 104 may be representative of any one or more communication networks, including fiber optic, cable, public switched telephone, cellular, satellite, wide area, local area, personal area, and/or any other wired and/or wireless networks. Although the system 100 of FIG. 1 is depicted as having a particular number of components, the system 100 can have any number of additional or alternative components (e.g., any number of electronic devices 102 and/or other components in communication with one another via one or more networks). Any or all of the components (e.g., the electronic devices 102) may include one or more processors and memory storing computer executable instructions to implement the functionality discussed herein attributable to the various electronic devices. By way of example and not limitation, the electronic devices 102 may include wearable devices (e.g., eyewear devices, e.g., glasses, headsets, helmets, earphones, earbuds, hearing aids, etc.), mobile devices (e.g., phones, tablets, etc.), charging cases or stations, video game systems or controllers, and/or other portable or stationary electronic devices.

In some examples, the host electronic device 120 may facilitate power distribution among the electronic devices 102 based on one or more power policies. As illustrated in FIG. 1, the host electronic device 120 may include one or more processor(s) 106, a memory 108 for storing one or more application(s) 110, a power management component 112, a power transmission component 114, and a networking component 116.

In some examples, the processor(s) 106 may include hardware for executing instructions, such as those making up a computer program or application. For example, to execute instructions, the processor(s) 106 may retrieve (or fetch) the instructions from an internal register, an internal cache, the memory 108, or other computer-readable media, and decode and execute them. By way of example and not limitation, the processor(s) 106 may comprise one or more central processing units (CPUs), graphics processing units (GPUs), holographic processing units, microprocessors, microcontrollers, integrated circuits, programmable gate arrays, or other hardware components usable to execute instructions.

The memory 108 is an example of computer-readable media and is communicatively coupled to the processor(s) 106 for storing data, metadata, and programs for execution by the processor(s) 106. In some examples, the memory 108 may constitute non-transitory computer-readable media such as one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 108 may include multiple instances of memory and may include internal and/or distributed memory. The memory 108 may include removable and/or non-removable storage. The memory 108 may additionally or alternatively include one or more hard disk drives (HDDs), flash memory, Universal Serial Bus (USB) drives, or a combination these or other storage devices.

The memory 108 may store one or more application(s) 110, which may include, among other things, an operating system (OS), productivity applications (e.g., word processing applications), communication applications (e.g., email, messaging, social networking applications, etc.), games, or the like. The application(s) 110 may be implemented as one or more stand-alone applications, as one or more modules of an application, as one or more plug-ins, as one or more library functions application programming interfaces (APIs) that may be called by other applications, and/or as a cloud-computing model. The application(s) 110 can include local applications configured to be executed locally on the host electronic device 120, one or more web-based applications hosted on a remote server, and/or as one or more mobile device applications or “apps.”

The networking component 116 may send or receive data wirelessly to or from one or more of the electronic devices 102. The networking component 116 can include hardware, software, or both. In some examples, the networking component 116 may provide one or more interfaces for physical and/or logical communication (such as, for example, packet-based communication) between the host electronic device 120 and one or more electronic devices 102. As an example, and not by way of limitation, the networking component 116 may include a network interface controller (NIC) or network adapter for communicating with an Ethernet or other wire-based network and/or a wireless NIC (WNIC) or wireless adapter for communicating with a wireless network, such as a WI-FI adapter. In some examples, the networking component 116 can additionally include a bus, which can include hardware (e.g., wires, traces, radios, etc.), software, or both that communicatively couple components of one or more of the electronic devices 102.

In some examples, the networking component 116 may receive state data associated with the electronic devices 102. The state data may include power condition data representing power conditions of the electronic devices 102. For example, the host electronic device 120 may include the electronic device 102(A) (e.g., a head-mounted device) that are configured to receive power conditions associated with the electronic devices 102(A)-102(N) (e.g., a head-mounted device, a mobile device, a charging case, a left-handed controller, and/or a right-handed controller). In some examples, sensors included in the electronic devices 102(A)-102(N) can monitor various types of information in real-time or periodically. For example, the sensors included in the electronic devices 102 can monitor the power condition associated with the electronic devices 102 in real-time, such as the remaining power levels of the electronic devices 102 (e.g., 10%, 20%, 40%, 75%, 100%, etc.), estimated battery time remaining associated with the electronic devices 102 (e.g., 10 minutes, 30 minutes, 1 hour, 2 hours, etc.), etc. The electronic devices 102 may further transmit the power conditions to the networking component 116 of the host electronic device 120 in real-time. As another example, the sensors included in the electronic devices can monitor the power conditions associated with the electronic devices 102 periodically, such as every 10 minutes, every 20 minutes, every 30 minutes, etc.

In some examples, the power management component 112 may determine, based on the power condition data, a first electronic device of the electronic devices 102 to wirelessly receive power from one or more of the electronic devices 102. In some examples, the power management component 112 may determine the first electronic device of the electronic devices 102 to wirelessly receive power by comparing the power condition data with a threshold value. For example, the power management component 112 may compare the remaining power levels of the electronic devices 102 with a first threshold power level (e.g., 20%, 25%, 30%, etc.), and determine the first electronic device of the electronic devices 102 to wirelessly receive power based on determining the remaining power level of the first electronic device is less than or equal to the first threshold power level. In some examples, the power management component 112 may determine the first electronic device of the electronic devices 102 to wirelessly receive power by ranking the electronic devices 102 based on the power condition data.

In some examples, one or more power policies may be stored in or in association with the power management component 112. The one or more power policies may define one or more conditions (e.g., system states) under which the various power policies should be applied. Examples of the one or more conditions may include, but are not limited to, an indication of a running application associated with the one or more electronic devices, a current or predicted activity level associated with the one or more electronic devices, importance scores associated with the one or more electronic devices, number of charge cycles associated with the one or more electronic devices, a dominant hand preference associated with a user indicating whether the user favors right-handed use or left-handed use, or other conditions. The one or more power policies may be implemented in a variety of ways including, for example, as one or more look up tables mapping state data to power policies, or as a state machine that for a given set of device states determines an applicable power policy. In some examples, each condition of the one or more conditions may map to a different power policy. In some examples, two or more conditions may map to a single power policy.

In some examples, the power management component 112 may determine, based on the state data, one or more applicable power policies. The power management component 112 may further manage power distribution among the electronic devices 102 based on the one or more applicable power policies.

In some examples, the state data may further include an indication of a running application associated with the electronic devices 102. For example, the electronic device 102(A) can keep track of applications executing on the device and send a list of currently running applications to the host electronic device 120.

In some examples, the state data may further include a current or predicted activity level associated with the electronic devices 102. In one example, one or more of the electronic devices 102 can include one or more activity sensors for collecting data concerning user activity or movement. The one or more activity sensors may include one or more of an accelerometer, a heart rate monitor, an altitude sensor, a pedometer, etc. One or more of the electronic devices 102 can determine a current user activity level associated with the electronic devices 102 based on motion data provided by one or more of the activity sensors. In another example, the electronic device 102(A) can keep track of current applications executing on the device and determine a predicted user activity level associated with the electronic devices 102 based on the current applications executing on the device.

In some examples, the state data may further include importance scores associated with the electronic devices 102. For example, a controller and/or a mobile device may have a relatively high importance score compared to a charging case. In some examples, the importance score may be provided by a user associated with the electronic devices 102.

In some examples, the state data may further include the number of charge cycles associated with the electronic devices 102. For example, the electronic devices 102 can store information relating to charge cycles applied to batteries in the electronic devices 102, such as the number of charge cycles, the amount of charging for some or all of the charge cycles, etc.

In some examples, the state data may further include a dominant hand preference associated with a user indicating whether the user favors right-handed use or left-handed use. In one example, the dominant hand preference may be provided by a user associated with the electronic devices 102. In another example, the dominant hand preference may be determined by the electronic devices 102 based on log data. For example, the electronic device 102(B) (e.g., a mobile device) can keep track of touch input data and determine an activity frequency of a user relative to each one or multiple regions on the electronic device 102(B). The electronic device 102(B) may determine the user favors right-handed use based on a relatively high activity frequency in the right-side region of the electronic device 102(B) compared to the left-side region.

In some examples, the power management component 112 may determine, based on the power condition data, a second electronic device of the electronic devices 102 to wirelessly provide power to the first electronic device. For example, the power management component 112 may determine the second electronic device of the electronic devices 102 to wirelessly provide power by ranking the electronic devices 102 based on the power condition data. As another example, the power management component 112 may compare the remaining power levels of the electronic devices 102 with a second threshold power level (e.g., 70%, 75%, 80%, etc.), and determine the second electronic device of the electronic devices 102 to wirelessly provide power based on determining the remaining power level of the second electronic device is greater than or equal to the second threshold power level.

In some examples, the power management component 112 may further determine, based on the power condition data, a charge imbalance between the first electronic device and at least one of the electronic devices 102. In some examples, the charge imbalance could be in terms of the percentage of charge of the first electronic device and at least one of the electronic devices 102 being more than a threshold difference (e.g., greater than 10% difference in charge). In some examples, the charge imbalance could be an absolute difference in charge capacity of the first electronic device and at least one of the electronic devices 102 (e.g., greater than 100 Amp Hour difference in charge capacity). The power management component 112 may determine, based on the power condition data and the charge imbalance, the second device to wirelessly provide power to the first device.

In some examples, the power management component 112 may determine there are two or more electronic devices 102 with remaining power levels greater than or equal to the second threshold power level. Alternatively, the power management component 112 may determine there are charge imbalances between the first electronic device and two or more electronic devices 102. In such situations, the power management component 112 may determine one or more applicable power policies based on the state data. The power management component 112 may further determine, based on the one or more applicable power policies, the second electronic device of the electronic devices 102 to wirelessly provide power to the first electronic device.

In some examples, the one or more power policies are associated with a running application. The power management component 112 can determine, based on the power condition data and an indication of a running application associated with the electronic devices 102, the second electronic device of the electronic devices 102 to wirelessly provide power to the first electronic device. For example, the power condition data may indicate that a mobile device (e.g., the electronic device 102(B)) and controllers (e.g., the electronic device 102(M) and 102(N)) have remaining power levels greater than or equal to the second threshold power level. The state data may include an indication of a running game or other applications associated with the electronic devices 102. The power management component 112 may determine, based on the indication of a running game, an applicable power policy of prioritizing controllers. The power management component 112 may assign, based on the applicable power policy, the lowest importance rank to the mobile device (e.g., the electronic device 102(B)) among the electronic devices 102(B), 102(M), and 102(N). Thus, the power management component 112 may determine, based on the power condition data and the indication of a running game associated with the electronic devices 102, the mobile device (e.g., the electronic device 102(B)) to wirelessly provide power to the first electronic device.

In some examples, the one or more power policies are associated with a current or predicted activity level. The power management component 112 can determine, based on the power condition data and a current or predicted activity level associated with the electronic devices 102, the second electronic device of the electronic devices 102 to wirelessly provide power to the first electronic device. For example, the power condition data may indicate that a mobile device (e.g., the electronic device 102(B)) and controllers (e.g., the electronic device 102(M) and 102(N)) have remaining power levels greater than or equal to the second threshold power level. The state data may include a high activity level associated with the electronic devices 102 (e.g., a high activity level may be assigned to the electronic devices 102 when a user is playing a VR rhythm game, while a low activity level may be assigned to the electronic devices 102 when the user is having a conference call). The power management component 112 may determine, based on the high activity level, an applicable power policy of prioritizing controllers. The power management component 112 may assign, based on the applicable power policy, the lowest importance rank to the mobile device (e.g., the electronic device 102(B)). Thus, the power management component 112 may determine, based on the power condition data and the high activity level associated with the electronic devices 102, the mobile device (e.g., the electronic device 102(B)) to wirelessly provide power to the first electronic device.

In some examples, the one or more power policies are associated with importance scores assigned to the electronic devices 102. The power management component 112 can determine, based on the power condition data and importance scores assigned to the electronic devices 102, the second electronic device of the electronic devices 102 to wirelessly provide power to the first electronic device. For example, the power condition data may indicate that the electronic devices 102(B)-102(N) have remaining power levels greater than or equal to the second threshold power level. The state data may include importance scores assigned to the electronic devices 102. The power management component 112 may determine, based on the importance scores, an applicable power policy of prioritizing electronic devices based on importance scores. For example, a controller (e.g., the electronic device 102(M) or 102(N)) may have a relatively high importance score than a charging case (e.g., the electronic device 102(C)) and may be assigned with a relatively high priority compared to the charging case. Thus, the power management component 112 may determine, based on the power condition data and importance scores associated with the electronic devices 102(B)-102(N), the charging case (e.g., the electronic device 102(C)) to wirelessly provide power to the first electronic device.

In some examples, the one or more power policies are associated with the number of charge cycles associated with the electronic devices 102. The power management component 112 can determine, based on the power condition data and the number of charge cycles associated with the electronic devices 102, the second electronic device of the electronic devices 102 to wirelessly provide power to the first electronic device. For example, the power condition data may indicate that the electronic devices 102(B)-102(N) have remaining power levels greater than or equal to the second threshold power level. The state data may include the number of charge cycles associated with the electronic devices 102. The power management component 112 may determine, based on the number of charge cycles associated with the electronic devices 102, an applicable power policy of disfavoring an electronic device with a relatively large number of charge cycles for providing power. For example, the number of charge cycles of a mobile device (e.g., the electronic device 102(B)) may be larger than the number of charge cycles of a charging case (e.g., the electronic device 102(C)). The power management component 112 may determine, based on the power condition data and the number of charge cycles associated with the electronic devices 102, the charging case (e.g., the electronic device 102(C)) to wirelessly provide power to the first electronic device.

In some examples, the one or more power policies are associated with a dominant hand preference associated with a user indicating whether the user favors right-handed use or left-handed use. The power management component 112 can determine, based on the power condition data and a dominant hand preference associated with a user, the second electronic device of the electronic devices 102 to wirelessly provide power to the first electronic device. For example, the power condition data may indicate that a left-handed controller (e.g., the electronic devices 102(M)) and a right-handed controller (e.g., the electronic devices 102(N)) both have remaining power levels greater than or equal to the second threshold power level. The state data may include a dominant hand preference associated with the user indicating the user favors left-handed use. The power management component 112 may determine, based on the dominant hand preference associated with the user indicating the user favors left-handed use, an applicable power policy of prioritizing left-handed controller. Thus, the power management component 112 may determine, based on the power condition data and dominant hand preference associated with the user indicating the user favors left-handed use, the right-handed controller (e.g., the electronic device 102(N)) to wirelessly provide power to the first electronic device.

In some examples, the state data can further include location data of the electronic devices 102. The power management component 112 may further use the location data to determine which device to use to charge the first device. For example, the power management component 112 may determine, based at least in part on the location data, a relative ability (e.g., efficiency) of the various electronic devices 102 to wirelessly charge one another. For instance, devices that are closer together may be able to more efficiency wirelessly charge one another than device that are further apart.

In some examples, the power management component 112 may generate a power distribution command configured to cause wireless power transmission from the second electronic device to the first electronic device. The power management component 112 may further transmit the power distribution command to the networking component 116 and cause the networking component 116 to send the power distribution command to at least one of the first electronic device or the second electronic device to initiate wireless power transmission from the second electronic device to the first electronic device. For example, the power distribution command may be generated and sent by the second electronic device to the first electronic device to cause the second electronic device to wirelessly charge the first electronic device. As another example, the power distribution command may be generated by the first electronic device to initiate wireless power transmission from the second electronic device to the first electronic device.

The power transmission component 114 may be configured to wirelessly receive and/or provide power to or from one or more electronic devices 102. In some instances, the power transmission component 114 may include a transmitter configured to wirelessly provide power to one or more electronic devices 102 and a receiver configured to wirelessly receive power to the one or more electronic devices 102. In some examples, the power transition component 114 may be configured to implement wireless charging at a distance. For instance, in some examples, the power transmission component 114 may be configured to transmit and/or receive power wirelessly from a device located up to 15 feet away. In some examples, the power transmission component 114 may be configured to transmit and/or receive power wirelessly from a device located between about 1 and about 6 feet away. In some examples, the power transmission component 114 may employ mid-field or far-field charging technology and may include radio frequency based wireless power receivers and transmitters. Without limitation, a few examples of radio frequency based wireless power receivers and transmitters that can be used include those marketed under the trademark WattUp® and available from Energous Corporation, with place of business in San Jose, California, and those marketed under the trademark Powercast® and available from Powercast Corp., with place of business in Pittsburgh, Pennsylvania.

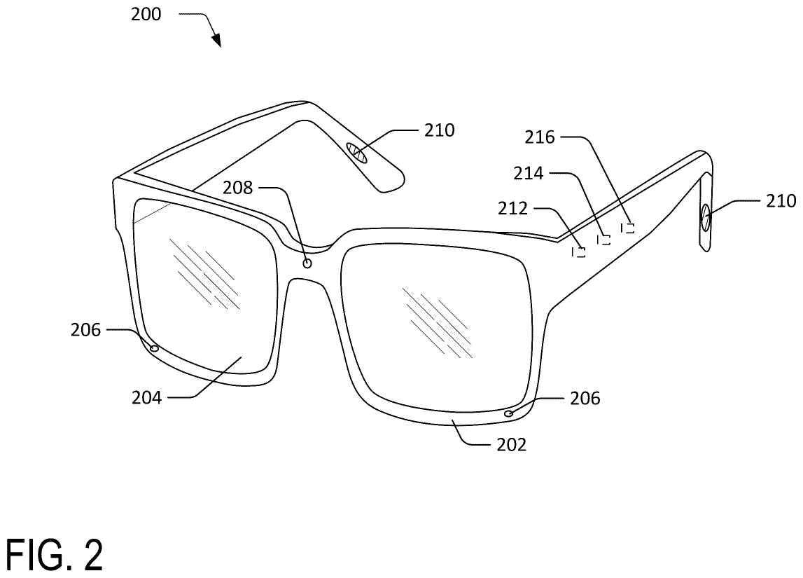

FIG. 2 is a perspective view of an example apparatus, implemented as an eyewear device, configured to manage power distribution among electronic devices based on one or more power policies, in accordance with one or more examples.

In some examples, the eyewear device is a near-eye display (NED). In general, the headset 200 may be worn on the face of a user such that content (e.g., media content) is presented using a display assembly and/or an amplification system. Examples are also considered in which the headset 200 presents media content to a user in a different manner. Examples of media content presented by the headset 200 include one or more images, video, audio, or some combination thereof. The headset 200 includes a frame 202, and may include, among other components, a display assembly including one or more display elements 204, a depth camera assembly (DCA), and an amplification system. While FIG. 2 illustrates the components of the headset 200 in example locations on the headset 200, the components may be located elsewhere on the headset 200, on a peripheral device paired with the headset 200, or some combination thereof. Similarly, there may be more or fewer components on the headset 200 than what is shown in FIG. 2.

The frame 202 may hold the other components of the headset 200. In some examples, the frame 202 includes a front portion that holds the one or more display elements 204, and end pieces (e.g., temples) to attach the headset 200 to a head of the user. In some cases, the front portion of the frame 202 bridges the top of a nose of the user. The length of the end pieces may be adjustable (e.g., adjustable temple length) to fit different users. The end pieces may also include a portion that curls behind the ear of the user (e.g., temple tip, earpiece, etc.).

The one or more display elements 204 may emit light visible to a user wearing the headset 200. As illustrated, the headset 200 includes a display element 204 for each eye of a user, although other configurations of the display elements are also considered. In some examples, a display element 204 generates image light that is provided to an eyebox of the headset 200. The eyebox may correspond to a location in space that an eye of user occupies while wearing the headset 200. For example, a display element 204 may be a waveguide display. A waveguide display includes a light source (e.g., a two-dimensional source, one or more line sources, one or more point sources, etc.) and one or more waveguides. Light from the light source is in-coupled into the one or more waveguides which outputs the light in a manner such that there is pupil replication in an eyebox of the headset 200. In some examples, the display elements 204 may use one or more diffraction gratings to perform in-coupling and/or outcoupling of light from the one or more waveguides. In some examples, the waveguide display includes a scanning element (e.g., waveguide, mirror, etc.) that scans light from the light source as the light is in-coupled into the one or more waveguides. In some cases, one or both of the display elements 204 are opaque and do not transmit light from a local area or environment around the headset 200 through the display elements 204 to the eyebox. For example, the local area may be a room that a user wearing the headset 200 is inside, or the user wearing the headset 200 may be outside and the local area is an outside area. In cases in which the display elements 204 are opaque, the headset 200 may generate VR content to be viewed via the display elements 204. Examples are also considered in which one or both of the display elements 204 are at least partially transparent, such that light from the local area may be combined with light from the one or more display elements 204 to produce AR and/or MR content.

In some examples, a display element 204 is a lens that transmits light from the local area to the eyebox. For instance, one or both of the display elements 204 may be a lens without correction (non-prescription) or a prescription lens (e.g., single vision, bifocal and trifocal, or progressive) to help correct for defects in a user's eyesight. In some examples, the display element 204 may be polarized and/or tinted to protect the user's eyes from the sun.

In some examples, the display element 204 may include an optics block (not shown). The optics block may include one or more optical elements (e.g., lens, Fresnel lens, etc.) that direct light from the display element 204 to the eyebox. The optics block may, in some cases, correct for aberrations in some or all of the image content, magnify some or all of the image, or some combination thereof.

The DCA may determine depth information for a portion of a local area surrounding the headset 200. In some examples, the DCA includes one or more imaging devices 206, a DCA controller (not shown in FIG. 2), and an illuminator 208. In some examples, the illuminator 208 illuminates a portion of the local area with light. The light may be, for instance, structured light (e.g., dot pattern, bars, etc.) in the infrared (IR), IR flash for time-of-flight, and so forth. In some examples, the one or more imaging devices 206 capture images of the portion of the local area that include the light from the illuminator 208. The example headset 200 includes a single illuminator 208 and two imaging devices 206, but alternate configurations including differing numbers of illuminators and/or imaging devices are also considered.

The DCA controller may compute depth information for at least a portion of the local area using captured images and one or more depth determination techniques. The DCA controller may utilize depth determination techniques such as, but not limited to, direct time-of-flight (ToF) depth sensing, indirect ToF depth sensing, structured light, passive stereo analysis, active stereo analysis (e.g., using texture added to the scene by light from the illuminator 208), other technique(s) to determine the depth of a scene, or some combination thereof. In some examples, the headset 200 may perform simultaneous localization and mapping (SLAM) for a position of the headset 200 and updating of a model of the local area. For example, the headset 200 may include a passive camera assembly (PCA) that generates color image data. The PCA may include one or more RGB cameras that capture images of some or all of the local area. In some examples, some or all of the imaging devices 206 of the DCA may also function as the PCA. The images captured by the PCA and the depth information determined by the DCA may be used by the headset 200 to determine parameters of the local area, generate a model of the local area, update a model of the local area, or some combination thereof. In some examples, the headset 200 may include one or more sensor arrays 210 that generate measurement signals in response to the motion of the headset 200 and tracks the position (e.g., location and pose) of the headset 200 within the room. The sensor array(s) 210 may include, for example, an optical displacement sensor, an inertial measurement unit, an accelerometer, a gyroscope, or another suitable type of sensor that detects motion, or some combination thereof.

In some examples, the headset 200 includes a power management component 212, a power transmission component 214, and a networking component 216 (described in more detail in relation to FIG. 1). The networking component 216 may send or receive data wirelessly to or from one or more electronic devices. In some examples, the networking component 216 may receive state data associated with the one or more electronic devices. Examples of state data include, but are not limited to, power condition data representing power conditions associated with the one or more electronic devices (e.g., one or more electronic devices 102), an indication of a running application associated with the one or more electronic devices, a current or predicted activity level associated with the one or more electronic devices, importance scores associated with the one or more electronic devices, number of charge cycles associated with the one or more electronic devices, a dominant hand preference associated with a user indicating whether the user favors right-handed use or left-handed use, or other state data.

The power management component 212 may determine, based on the power condition data, a first electronic device of the one or more electronic devices to wirelessly receive power from one or more of the electronic devices. The power management component 212 may determine one or more applicable power policies based on the state data. The power management component 212 may further manage power distribution among the electronic devices based on the one or more applicable power policies.

In some examples, one or more power policies are associated with a running application. For example, the power management component 212 may determine, based at least in part on the running application, an importance rank of the electronic devices. The power management component 212 may further determine, based on the power condition data and the importance rank, a second device to wirelessly provide power to the first device.

In some examples, one or more power policies are associated with a current or predicted activity level associated with the electronic devices. For example, the power management component 212 may determine, based on the current or predicted activity level associated with the electronic devices, an importance rank of the electronic devices. The power management component 212 may further determine, based on the power condition data and the importance rank, the second device to wirelessly provide power to the first device.

In some examples, one or more power policies are associated with importance scores associated with the electronic devices. For example, the power management component 212 may determine importance scores associated with the electronic devices. The power management component 212 may further determine, based on the power condition data and the importance scores, the second device to wirelessly provide power to the first device.

In some examples, one or more power policies are associated with charge cycles associated with the electronic devices. For example, the power management component 212 may determine, based on the power condition data and the charge cycles, the second device to wirelessly provide power to the first device.

In some examples, one or more power policies are associated with a dominant hand preference associated with a user indicating whether the user favors right-handed use or left-handed use. For example, the power management component 212 may determine, based on the power condition data and the dominant hand preference, the second device to wirelessly provide power to the first device.

In some examples, one or more power policies are associated with a charge imbalance between the first electronic device and at least one of the electronic devices. For example, the power management component 212 may determine, based on the power condition data, a charge imbalance between the first device and at least one of the electronic devices. The power management component 212 may further determine, based on the power condition data and the charge imbalance, the second device to wirelessly provide power to the first device.

The power management component 212 may generate a power distribution command configured to cause wireless power transmission from the second electronic device to the first electronic device. The power management component 212 may further transmit the power distribution command to the networking component 216 and cause the networking component 216 to send the power distribution command to at least one of the first electronic device or the second electronic device to initiate wireless power transmission from the second electronic device to the first electronic device.

The power transmission component 214 may wirelessly receive and/or provide power to and/or from one or more electronic devices. In some instances, the power transmission component 214 may include a transmitter configured to wirelessly provide power to one or more electronic devices and a receiver configured to wirelessly receive power to the one or more electronic devices.

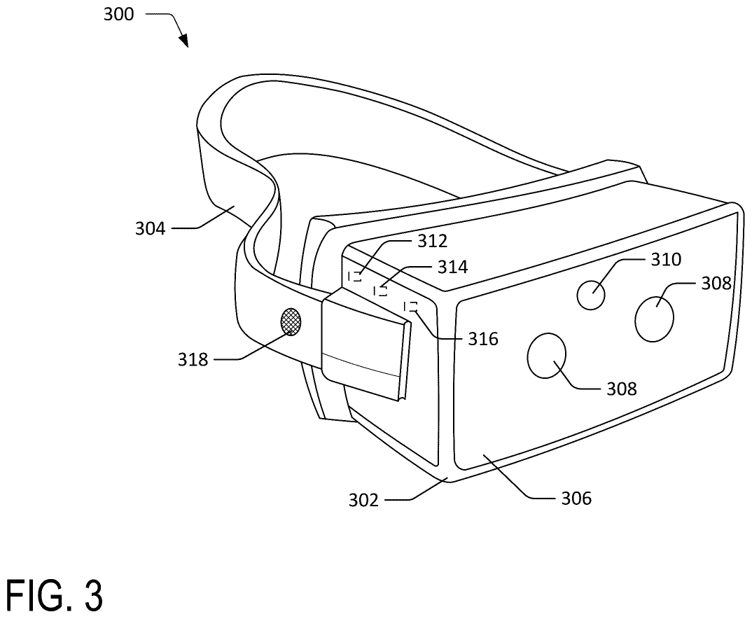

FIG. 3 is a perspective view of an example apparatus, implemented as a head-mounted display (HMD) 300, configured to manage power distribution among electronic devices based on one or more power policies, in accordance with one or more examples. In some examples, portions of a front side of the HMD 300 are at least partially transparent in the visible band (e.g., ˜380 nm to 750 nm), and portions of the HMD 300 that are between the front side of the HMD 300 and an eye of the user are at least partially transparent (e.g., a partially transparent electronic display). The HMD 300 includes a front rigid body 302 and a strap or band 304. In some examples, the HMD 300 includes some or all of the same components described above with reference to FIG. 2, which may be modified to integrate with the form factor of the HMD 300. For example, the HMD 300 may include a display assembly 306, a DCA, and an amplification system. Additionally, in some examples, the HMD 300 includes one or more cameras or other imaging devices 308 to capture images of an environment surrounding the HMD 300, an illuminator 310 for illuminating at least a portion of the environment surrounding the HMD 300, a power management component 312, a power transmission component 314, a networking component 316, and one or more other sensors 318 (e.g., optical displacement sensors, inertial measurement units, accelerometers, gyroscopes, or other sensors to detect motion or other conditions or associated with the HMD 300). Different components may be located in various locations, such as coupled to the band 304, coupled to the front rigid body 302, or may be configured to be inserted within the ear canal of a user, to name a few examples.

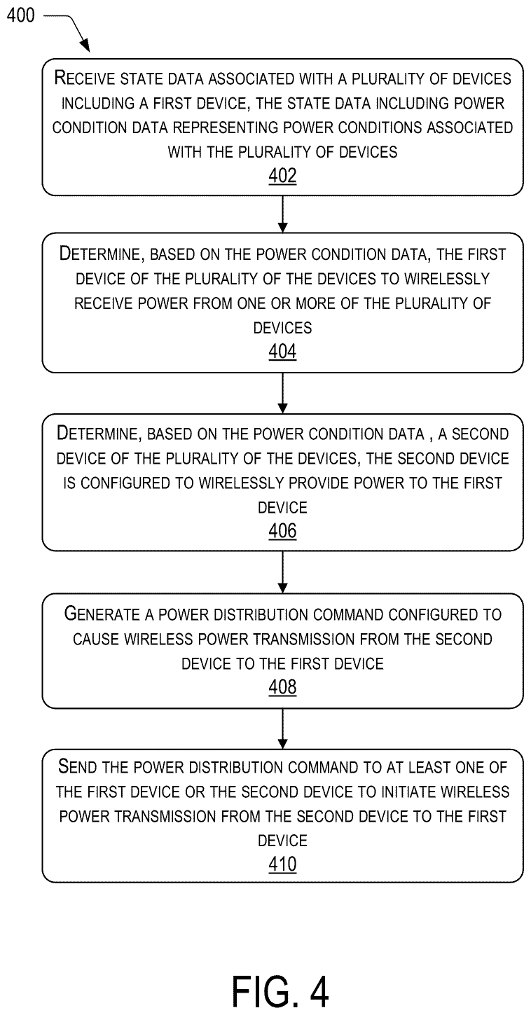

FIG. 4 is a flowchart of an example process for managing power distribution among electronic devices based on one or more power policies, in accordance with one or more examples. Process 400 may be performed by components of a system (e.g., the host electronic device 120, the headset 200, or the HMD 300). In some cases, the process 400 may include different and/or additional operations, or perform the operations in a different order than described herein.

At operation 402, the process 400 includes receiving state data associated with a plurality of devices including a first device, the state data including power condition data representing power conditions associated with the plurality of devices. Examples of state data may further include, but are not limited to, an indication of a running application associated with the plurality of devices, a current or predicted activity level associated with the plurality of devices, importance scores associated with the plurality of devices, number of charge cycles associated with the plurality of devices, a dominant hand preference associated with a user indicating whether the user favors right-handed use or left-handed use, or other state data. Examples of the plurality of devices include, but are not limited to, wearable devices (e.g., eyewear devices, e.g., glasses, headsets, helmets, earphones, earbuds, hearing aids, etc.), mobile devices (e.g., phones, tablets, etc.), charging cases or stations, video game systems or controllers, and/or other portable or stationary electronic devices.

At operation 404, the process 400 includes determining, based on the power condition data, the first device of the plurality of the devices to wirelessly receive power from one or more of the plurality of the devices. Examples of the power condition data include, but are not limited to, remaining power levels of the plurality of the devices (e.g., 10%, 20%, 40%, 75%, 100%, etc.), estimated battery time remaining associated with the plurality of the devices (e.g., 10 minutes, 30 minutes, 1 hour, 2 hours, etc.), etc.

At operation 406, the process 400 includes determining, based on based on the power condition data, a second device of the plurality of the devices, the second device is configured to wirelessly provide power to the first device.

At operation 408, the process 400 includes generating a power distribution command configured to cause wireless power transmission from the second device to the first device.

At operation 410, the process 400 includes sending the power distribution command to at least one of the first device or the second device to initiate wireless power transmission from the second device to the first device. In some examples, the system includes a head-mounted device (e.g., HMD 300). The head-mounted device includes a wireless power transmission component configured to at least one of send or receive power wirelessly to/from the plurality of devices. The head-mounted device further includes a networking component configured to at least one of send or receive data wirelessly to/from the plurality of devices.

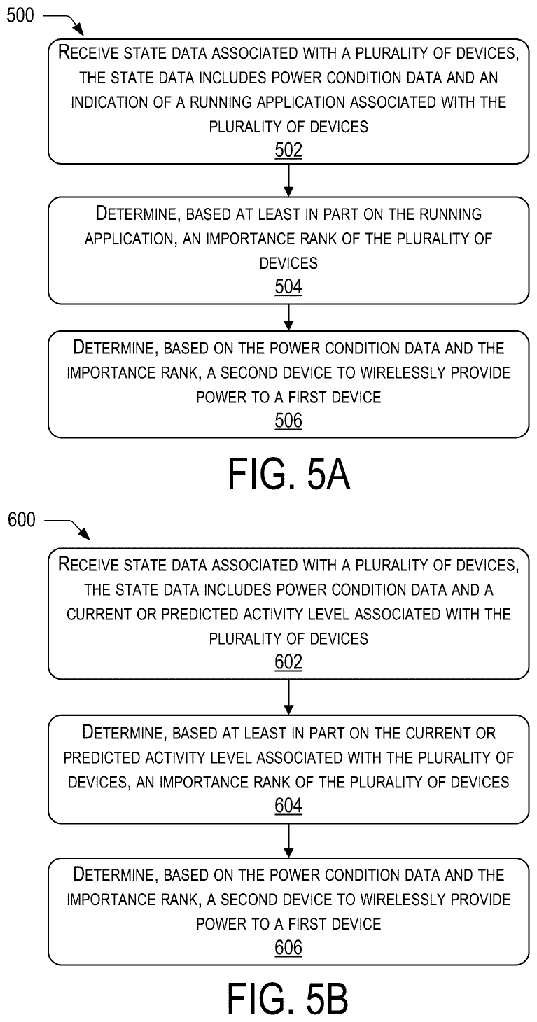

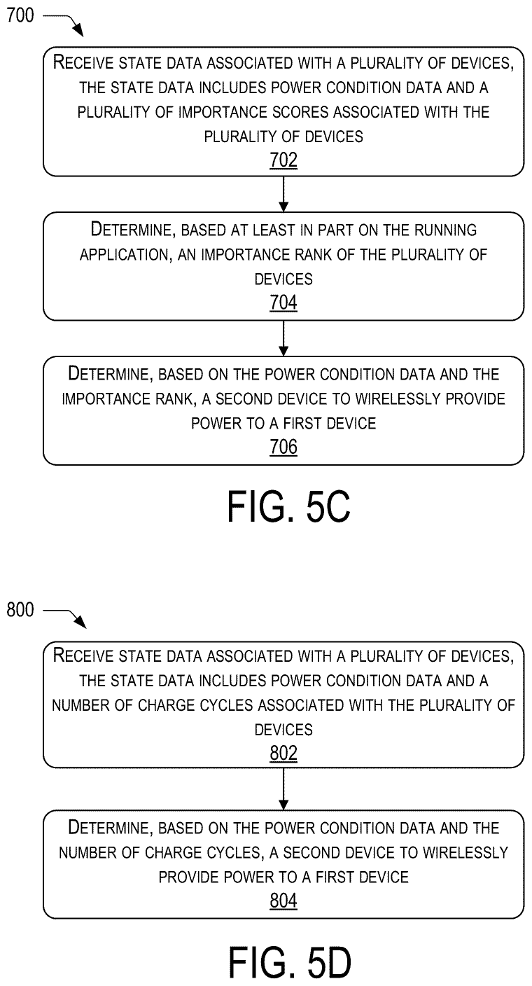

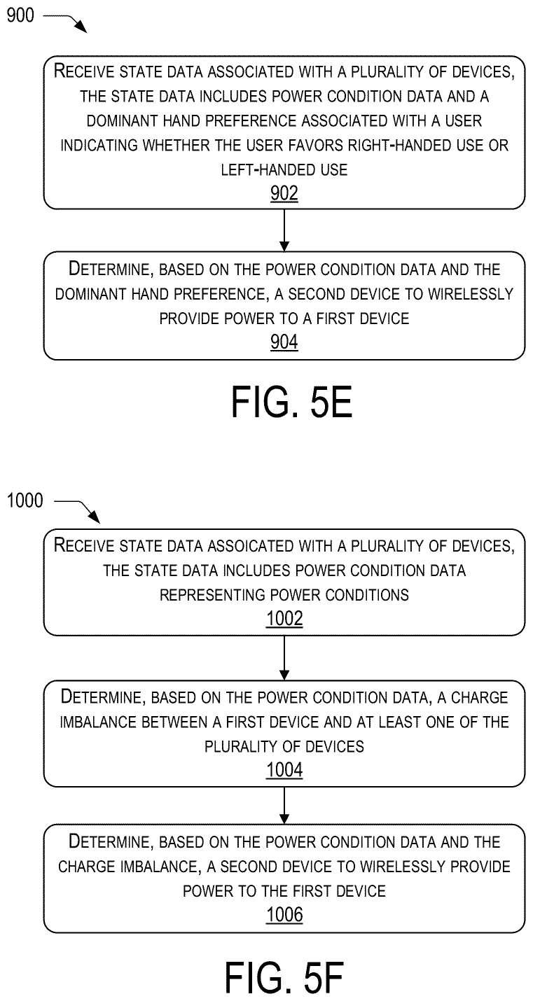

FIGS. 5A-5F are flowcharts of example processes for managing power distribution among electronic devices based on one or more power policies, in accordance with one or more examples. These processes may be performed by components of a system (e.g., the host electronic device 120, the headset 200, or the HMD 300). In some cases, these processes may include different and/or additional operations, or perform the operations in a different order than described herein.

FIG. 5A is a flowchart of an example process 500 for managing power distribution among electronic devices based on one or more power policies associated with a running application, in accordance with one or more examples.

At operation 502, the process 500 can include receiving state data associated with a plurality of devices. The state data includes power condition data associated with the plurality of devices and an indication of a running application associated with the plurality of devices.

At operation 504, the process 500 can include determining, based at least in part on the running application, an importance rank of the plurality of devices.

At operation 506, the process 500 can include determining, based on the power condition data and the importance rank, a second device of the plurality of devices to wirelessly provide power to a first device of the plurality of devices.

FIG. 5B is a flowchart of an example process 600 for managing power distribution among electronic devices based on one or more power policies associated with a current or predicted activity level, in accordance with one or more examples.

At operation 602, the process 600 can include receiving state data associated with a plurality of devices. The state data includes power condition data associated with the plurality of devices and an indication of a current or predicted activity level associated with the plurality of devices.

At operation 604, the process 600 can include determining, based at least in part on the current or predicted activity level, an importance rank of the plurality of devices.

At operation 606, the process 600 can include determining, based on the power condition data and the importance rank, a second device of the plurality of devices to wirelessly provide power to a first device of the plurality of devices.

FIG. 5C is a flowchart of an example process 700 for managing power distribution among electronic devices based on one or more power policies associated with importance scores, in accordance with one or more examples.

At operation 702, the process 700 can include receiving state data associated with a plurality of devices. The state data includes power condition data associated with the plurality of devices and a plurality of importance scores associated with the plurality of devices.

At operation 704, the process 700 can include determining, based at least in part on the plurality of importance scores, an importance rank of the plurality of devices.

At operation 706, the process 700 can include determining, based on the power condition data and the importance rank, a second device of the plurality of devices to wirelessly provide power to a first device of the plurality of devices.

FIG. 5D is a flowchart of an example process 800 for managing power distribution among electronic devices based on one or more power policies associated with charge cycles, in accordance with one or more examples.

At operation 802, the process 800 can include receiving state data associated with a plurality of devices. The state data includes power condition data associated with the plurality of devices and a number of charge cycles associated with the plurality of devices.

At operation 804, the process 800 can include determining, based on the power condition data and the number of charge cycles, a second device of the plurality of devices to wirelessly provide power to a first device of the plurality of devices.

FIG. 5E is a flowchart of an example process 900 for managing power distribution among electronic devices based on one or more power policies associated with a dominant hand preference, in accordance with one or more examples.

At operation 902, the process 900 can include receiving state data associated with a plurality of devices. The state data includes power condition data associated with the plurality of devices and a dominant hand preference associated with a user indicating whether the user favors right-handed use or left-handed use.

At operation 904, the process 900 can include determining, based on the power condition data and the dominant hand preference, a second device of the plurality of devices to wirelessly provide power to a first device of the plurality of devices.

FIG. 5F is a flowchart of an example process 1000 for managing power distribution among electronic devices based on one or more power policies associated with change imbalance, in accordance with one or more examples.

At operation 1002, the process 1000 can include receiving state data associated with a plurality of devices. The state data includes power condition data associated with the plurality of devices.

At operation 1004, the process 1000 can include determining, based on the power condition data, a charge imbalance between a first device and at least one of the plurality of devices.

At operation 1006, the process 1000 can include determining, based on the power condition data and the charge imbalance, a second device of the plurality of devices to wirelessly provide power to the first device of the plurality of devices.

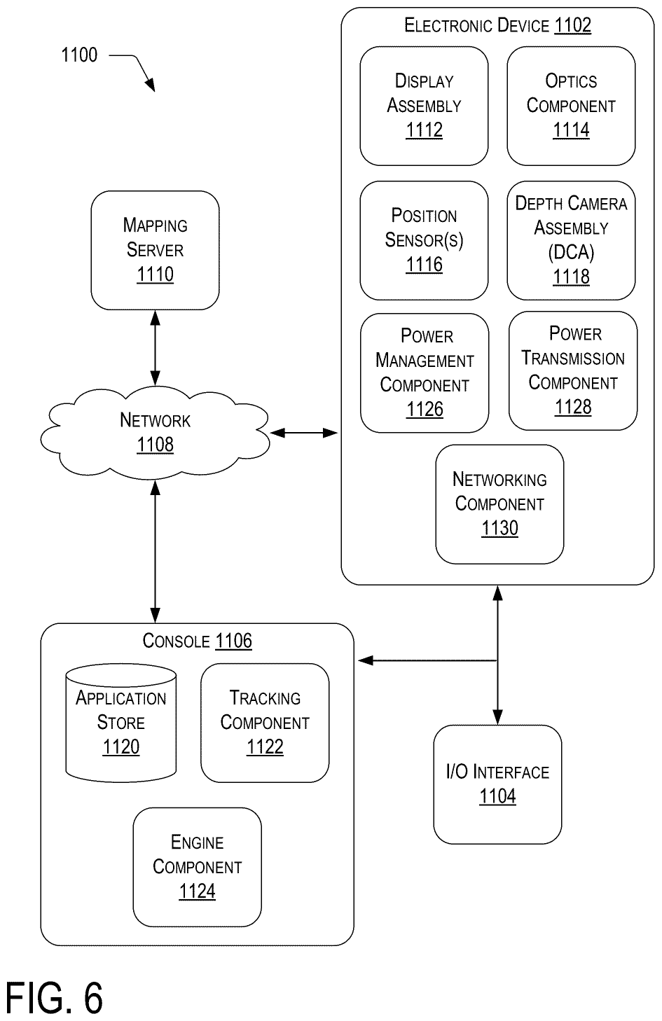

FIG. 6 is a block diagram of an example environment 1100 including a system for managing power distribution among electronic devices based on one or more power policies, in accordance with one or more examples. The example environment 1100 can include an artificial reality environment (e.g., a virtual reality environment, an augmented reality environment, a mixed reality environment, or some combination thereof). The example environment 1100 includes an electronic device 1102, an input/output (I/O) interface 1104 that is coupled to a console 1106, a network 1108, and a mapping server 1110, although the environment may include additional and/or alternate components. In some examples, the electronic device 1102 corresponds to the host electronic device 120 of FIG. 1, the headset 200 of FIG. 2, the HMD 300 of FIG. 3, one or more hearing aids, a mobile device, a charging case, a charging station, a controller, a tablet, a vehicle, or some other type of computing device that is configured to managing power distribution among electronic devices (not shown in FIG. 6) according to the described techniques.

While FIG. 6 shows an example environment 1100 including one electronic device 1102 and one I/O interface 1104, examples are considered in which any number of these components can be included in the example environment 1100. For example, there may be multiple electronic devices each having an associated I/O interface 1104, with each electronic device and I/O interface 1104 communicating with the console 1106. In some cases, different and/or additional components may be included in a system in the example environment 1100. Functionality described in relation to one or more of the components shown in FIG. 6 may be distributed among the components in a different manner than described herein. For example, some or all of the functionality of the console 1106 may be provided by the electronic device 1102.

In some examples, the electronic device 1102 can include a display assembly 1112, an optics component 1114, one or more position sensors 1116, a depth camera assembly (DCA) 1118, a power management component 1126, a power transmission component 1128, and a networking component 1130. Some examples of the electronic device 1102 have different components than those described in relation to FIG. 6. Additionally, the functionality provided by various components described in relation to FIG. 6 may be differently distributed among the components of the electronic device 1102, in some examples, or be captured in separate assemblies remote from the electronic device 1102.

In some examples, the display assembly 1112 displays content in accordance with data received from the console 1106. The display assembly 1112 can display the content using one or more display elements. A display element can be, for instance, an electronic display. In some examples, the display assembly 1112 can comprise a single display element or multiple display elements (e.g., a display for each eye of a user). Examples of an electronic display include, but are not limited to, a liquid crystal display (LCD), an organic light emitting diode (OLED) display, an active-matrix organic light-emitting diode display (AMOLED), a waveguide display, or some combination of these display types. In some examples, the display assembly 1112 can also be configured to perform some or all of the functionality of the optics component 1114.

In some examples, the optics component 1114 can magnify image light received from the display assembly 1112, correct optical errors associated with the image light, and present the corrected image light to one or both eye boxes of the electronic device 1102. In some examples, the optics component 1114 includes one or more optical elements such as an aperture, a Fresnel lens, a convex lens, a concave lens, a filter, a reflecting surface, or any other suitable optical element that can affect image light. In some cases, the optics component 1114 may include combinations of different optical elements. In some examples, one or more of the optical elements in the optics component 1114 can be coated by one or more coatings, such as partially reflective or anti-reflective coatings.

Magnification and focusing of the image light by the optics component 1114 allows an electronic display of the display assembly 1112 to be physically smaller, weigh less, and consume less power than larger displays. Additionally, magnification by the optics component 1114 can increase the field of view of the content presented by the electronic display. For example, the electronic display can display content in the field of view such that the displayed content is presented using almost all (e.g., approximately 110 degrees diagonal), and in some cases, all of a user's field of view. Additionally, in some examples, an amount of magnification can be adjusted by adding or removing optical elements of the optics component 1114.

In some examples, the optics component 1114 can be designed to correct one or more types of optical error. Examples of optical error include, but are not limited to, barrel or pincushion distortion, longitudinal chromatic aberrations, transverse chromatic aberrations, spherical aberrations, chromatic aberrations, or errors due to the lens field curvature, astigmatisms, and so forth. In some examples, content provided to the electronic display for display to a user can be pre-distorted, and the optics component 1114 can correct the distortion after receiving image light associated with the content.

In some examples, the position sensor(s) 1116 can be configured to generate data that indicates a position of the electronic device 1102. In some examples, the position sensor(s) 1116 generates one or more measurement signals in response to motion of the electronic device 1102. The position sensor(s) 1116 can include one or more of an IMU (Inertial Measurement Unit), accelerometer, gyroscope, magnetometer, another suitable type of sensor that detects motion, or some combination thereof. In some cases, the position sensor(s) 1116 can include multiple accelerometers to measure translational motion (forward/back, up/down, left/right) and multiple gyroscopes to measure rotational motion (e.g., pitch, yaw, roll). In some examples, the position sensor(s) 1116 include an IMU that rapidly samples measurement signals and calculates an estimated position of the electronic device 1102 from the sampled data. For example, the IMU can integrate the measurement signals received from the accelerometers over time to estimate a velocity vector and integrate the velocity vector over time to determine an estimated position of a reference point on the electronic device 1102 that describes a position of the electronic device 1102 in the environment. The reference point can be defined as a point in space and/or defined as a point within the electronic device 1102.

In some examples, the DCA 1118 generates depth information for an environment surrounding the electronic device 1102. The DCA 1118 can include one or more imaging devices, an illuminator, and a DCA controller (not shown). Operation and structure of the DCA 1118 is described above with regard to FIG. 1.

In some examples, the networking component 1130 can send or receive data wirelessly to or from one or more electronic devices. In some examples, the networking component 1130 can receive power condition data representing power conditions associated with the one or more electronic devices. In some examples, the networking component 1130 may receive state data associated with the one or more electronic devices. Examples of state data include, but are not limited to, an indication of a running application associated with the one or more electronic devices, a current or predicted activity level associated with the one or more electronic devices, importance scores associated with the one or more electronic devices, number of charge cycles associated with the one or more electronic devices, a dominant hand preference associated with a user indicating whether the user favors right-handed use or left-handed use, or other state data.

In some examples, the power management component 1126 can determine one or more applicable power policies based on the state data. The power management component 1126 may further manage power distribution among the one or more electronic devices based on the one or more applicable power policies.

In some examples, the power transmission component 1128 can wirelessly receive and/or provide power to or from the one or more electronic devices. In some instances, the power transmission component 1128 can include a transmitter configured to wirelessly provide power to the one or more electronic devices and a receiver configured to wirelessly receive power to the one or more electronic devices.

In some examples, the I/O interface 1104 can be a device that allows a user to send action requests and receive responses from the console 1106. In some examples, an action request can be an instruction to start or end capture of image or video data, or an instruction to perform a particular action within an application. The I/O interface 1104 can include one or more input devices, such as a keyboard, a mouse, a game controller, or any other suitable device for receiving action requests and communicating the action requests to the console 1106. In some examples, an action request received by the I/O interface 1104 is communicated to the console 1106, which performs an action corresponding to the action request. In some examples, the I/O interface 1104 includes an IMU that captures calibration data that indicates an estimated position of the I/O interface 1104 relative to an initial position of the I/O interface 1104. In some examples, the I/O interface 1104 can provide haptic feedback to the user in accordance with instructions received from the console 1106. For example, haptic feedback is provided when an action request is received, or the console 1106 communicates instructions to the I/O interface 1104 causing the I/O interface 1104 to generate haptic feedback when the console 1106 performs an action.

In some examples, the console 1106 provides content to the electronic device 1102 for processing in accordance with information received from one or more of the DCA 1118, the electronic device 1102, and/or the I/O interface 1104. In the example shown in FIG. 5, the console 1106 includes an application store 1120, a tracking component 1122, and an engine component 1124. Some examples of the console 1106 have additional and/or different components than those described in relation to FIG. 5. Additionally, the functions described below can be distributed among components of the console 1106 in a different manner than described in relation to FIG. 5. In some examples, the functionality discussed herein with respect to the console 1106 can be implemented in the electronic device 1102, and/or a remote system.

In some examples, the application store 1120 can store one or more applications for execution by the console 1106. An application is a group of instructions, that when executed by a processor, generates content for presentation to the user. Content generated by an application can be in response to inputs received from the user via movement of the electronic device 1102 and/or the I/O interface 1104. Examples of applications include, but are not limited to, gaming applications, conferencing applications, video playback applications, or other suitable applications.

In some examples, the tracking component 1122 tracks movements of the electronic device 1102 and/or of the I/O interface 1104 using information from the DCA 1118, the position sensor(s) 1116, or some combination thereof. For example, the tracking component 1122 determines a position of a reference point of the electronic device 1102 in a mapping of a local area of an environment based on information from the electronic device 1102. The tracking component 1122 can also determine positions of an object or virtual object. Additionally, in some examples, the tracking component 1122 can use data that indicates a position of the electronic device 1102 from the position sensor(s) 1116 as well as representations of the local area from the DCA 1118 to predict a future location of the electronic device 1102. The tracking component 1122 can provide the estimated or predicted future position of the electronic device 1102 and/or the I/O interface 1104 to the engine component 1124.

In some examples, the engine component 1124 can execute applications and receive position information, acceleration information, velocity information, predicted future positions, or some combination thereof, of the electronic device 1102 from the tracking component 1122. Based on the received information, the engine component 1124 can determine content to provide to the electronic device 1102 for presentation to the user. For example, if the received information indicates that the user has looked to the left, the engine component 1124 can generate content for the electronic device 1102 that mirrors the user's movement in a virtual local area or in a local area augmenting the local area with additional content. Additionally, the engine component 1124 can perform an action within an application executing on the console 1106 in response to an action request received from the I/O interface 1104 and provide feedback to the user that the action was performed. The provided feedback can be visual or audible feedback via the electronic device 1102, or haptic feedback via the I/O interface 1104.

In some examples, the network 1108 couples the electronic device, the console 1106, and the mapping server 1110. The network 1108 can include any combination of local area and/or wide area networks using both wireless and/or wired communication systems. For example, the network 1108 can include the Internet and/or mobile telephone networks. In some cases, the network 1108 uses standard communications technologies and/or protocols. Hence, the network 1108 can include links using technologies such as Ethernet, 802.11, worldwide interoperability for microwave access (WiMAX), 2G/3G/4G/5G mobile communications protocols, digital subscriber line (DSL), asynchronous transfer mode (ATM), InfiniBand, PCI (Peripheral Component Interconnect) Express Advanced Switching, and so forth. The networking protocols used on the network 1108 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and so on. The data exchanged over the network 1108 can be represented using technologies and/or formats including image data in binary form (e.g., Portable Network Graphics (PNG)), hypertext markup language (HTML), extensible markup language (XML), and the like. In some examples, all or some information can be encrypted using encryption technologies such as secure sockets layer (SSL), transport layer security (TLS), virtual private networks (VPNs), Internet Protocol security (IPsec), and so on.

In some examples, the mapping server 1110 can include a database that stores a virtual model describing a plurality of spaces, where a location in the virtual model corresponds to a current configuration of a local area of the electronic device 1102. The mapping server 1110 can receive, from the electronic device 1102 via the network 1108, information describing at least a portion of the environment surrounding the electronic device 1102 and/or location information for the environment surrounding the electronic device 1102. A user can adjust privacy settings to allow or prevent the electronic device 1102 from transmitting information to the mapping server 1110. In some examples, the mapping server 1110 determines, based on the received information and/or location information, a location in the virtual model that is associated with the local area of the environment where the electronic device 1102 is located. The mapping server 1110 can determine (e.g., retrieve) one or more acoustic parameters associated with the local area, based in part on the determined location in the virtual model and any acoustic parameters associated with the determined location. The mapping server 1110 can transmit the location of the local area and values of acoustic parameters associated with the local area to the electronic device 1102.

One or more components of the example environment 1100 can contain a privacy component that stores one or more privacy settings for user data elements. The user data elements describe the user and/or the electronic device 1102. For example, the user data elements can describe a physical characteristic of the user, an action performed by the user, a location of the user associated with the electronic device 1102, a location of the electronic device 1102, an HRTF (Head Related Transfer Function) for the user, and so forth. Privacy settings (or “access settings”) for a user data element can be stored in any suitable manner, such as, for example, in association with the user data element, in an index on an authorization server, in another suitable manner, or any suitable combination thereof.

A privacy setting for a user data element specifies how the user data element (or particular information associated with the user data element) can be accessed, stored, or otherwise used (e.g., viewed, shared, modified, copied, executed, surfaced, or identified). In some examples, the privacy settings for a user data element can specify a “blocked list” of entities that may not access certain information associated with the user data element. The privacy settings associated with the user data element may specify any suitable granularity of permitted access or denial of access. For example, some entities may have permission to see that a specific user data element exists, some entities may have permission to view the content of the specific user data element, and some entities may have permission to modify the specific user data element. The privacy settings may allow the user to allow other entities to access or store user data elements for a finite period of time.

The privacy settings may allow a user to specify one or more geographic locations from which user data elements can be accessed. Access or denial of access to the user data elements may depend on the geographic location of an entity who is attempting to access the user data elements. For example, the user may allow access to a user data element and specify that the user data element is accessible to an entity only while the user is in a particular location. If the user leaves the particular location, the user data element may no longer be accessible to the entity. As another example, the user may specify that a user data element is accessible only to entities within a threshold distance from the user, such as another user associated with an electronic device within the same local area as the user. If the user subsequently changes location, the entity with access to the user data element may lose access, while a new group of entities may gain access as they come within the threshold distance of the user.

The example environment 1100 may include one or more authorization/privacy servers for enforcing privacy settings. A request from an entity for a particular user data element can identify the entity associated with the request and the user data element can be sent only to the entity if the authorization server determines that the entity is authorized to access the user data element based on the privacy settings associated with the user data element. If the requesting entity is not authorized to access the user data element, the authorization server can prevent the requested user data element from being retrieved or can prevent the requested user data element from being sent to the entity. Although this disclosure describes enforcing privacy settings in a particular manner, this disclosure contemplates enforcing privacy settings in any suitable manner.

The foregoing description has been presented for illustration; it is not intended to be exhaustive or to limit the scope of the disclosure to the precise forms disclosed. Modifications and variations are contemplated considering the above disclosure.

Some portions of this description describe the examples in terms of algorithms and symbolic representations of operations on information. These algorithmic descriptions and representations may be used by those skilled in the data processing arts to convey the substance of their work effectively to others skilled in the art. These operations, while described functionally, computationally, or logically, are understood to be implemented by computer programs or equivalent electrical circuits, microcode, or the like. The described operations and their associated components may be embodied in software, firmware, hardware, or any combinations thereof.

Any of the operations or processes described herein may be performed or implemented with one or more hardware or software modules, alone or in combination with other devices. In some examples, a software module is implemented with a computer program product comprising a computer-readable medium containing computer program code, which can be executed by a computer processor for performing any or all the operations or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to a product that is produced by a computing process described herein. Such a product may comprise information resulting from a computing process, where the information is stored on a non-transitory, tangible computer readable storage medium and may include any example of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed is:

1. A system comprising:
one or more processors; and
one or more non-transitory computer-readable media storing instructions executable by the one or more processors, wherein the instructions, when executed, cause the system to perform operations comprising:
receiving state data associated with a plurality of devices including a first device, the state data including power condition data of the plurality of devices;
determining, based on the power condition data, a second device of the plurality of the devices to wirelessly provide power to the first device;
generating a power distribution command configured to cause wireless power transmission from the second device to the first device; and
sending the power distribution command to at least one of the first device or the second device to initiate wireless power transmission from the second device to the first device.

2. The system of claim 1, wherein the state data further comprises an indication of a running application associated with the plurality of devices, and the operations further comprise:
determining, based at least in part on the running application, an importance rank of the plurality of devices; and
determining, based on the power condition data and the importance rank, the second device to wirelessly provide power to the first device.

3. The system of claim 1, wherein the state data further comprises a current or predicted activity level associated with the plurality of devices, and the operations further comprise:
determining, based on the current or predicted activity level associated with the plurality of devices, an importance rank of the plurality of devices; and
determining, based on the power condition data and the importance rank, the second device to wirelessly provide power to the first device.

4. The system of claim 1, wherein the state data further comprises a plurality of importance scores associated with the plurality of devices, and the operations further comprise:
determining the plurality of importance scores associated with the plurality of devices; and
determining, based on the power condition data and the plurality of importance scores, the second device to wirelessly provide power to the first device.

5. The system of claim 1, wherein the state data further comprises a number of charge cycles associated with the plurality of devices, and the operations further comprise:
determining, based on the power condition data and the number of charge cycles, the second device to wirelessly provide power to the first device.

6. The system of claim 1, wherein the state data further comprises a dominant hand preference associated with a user indicating whether the user favors right-handed use or left-handed use, and the operations further comprise:
determining, based on the power condition data and the dominant hand preference, the second device to wirelessly provide power to the first device.

7. The system of claim 1, wherein the state data further comprises location data associated with the plurality of devices, and the operations further comprise:
determining, based on the power condition data and the location data of the plurality of devices, the second device to wirelessly provide power to the first device.

8. The system of claim 1, the operations further comprising:
determining, based on the power condition data, a charge imbalance between the first device and at least one of the plurality of the devices; and
determining, based on the power condition data and the charge imbalance, the second device to wirelessly provide power to the first device.

9. The system of claim 1, wherein the power distribution command is generated and sent by the second device to the first device to cause the second device to wirelessly charge the first device.

10. The system of claim 1, wherein the system comprises a head-mounted device comprising:
a wireless power transmission component configured to at least one of send or receive power wirelessly to or from the plurality of devices; and
a networking component configured to at least one of send or receive data wirelessly to or from the plurality of devices.

11. The system of claim 1, further comprising determining, based on the power condition data, the first device of the plurality of the devices to wirelessly receive power from second device.

12. A method comprising:
receiving state data associated with a plurality of devices including a first device, the state data including power condition data of the plurality of devices;
determining, based on the power condition data, a second device of the plurality of the devices to wirelessly provide power to the first device;
generating a power distribution command configured to cause wireless power transmission from the second device to the first device; and
sending the power distribution command to at least one of the first device or the second device to initiate wireless power transmission from the second device to the first device.

13. The method of claim 12, wherein the state data comprises an indication of a running application associated with the plurality of devices, the method further comprising:
determining, based at least in part on the running application, an importance rank of the plurality of devices; and
determining, based on the power condition data and the importance rank, the second device to wirelessly provide power to the first device.

14. The method of claim 12, wherein the state data comprises a current or predicted activity level associated with the plurality of devices, the method further comprising:
determining, based on the current or predicted activity level associated with the plurality of devices, an importance rank of the plurality of devices; and
determining, based on the power condition data and the importance rank, the second device to wirelessly provide power to the first device.

15. The method of claim 12, wherein the state data comprises a number of charge cycles associated with the plurality of devices, the method further comprising:
determining the number of charge cycles associated with the plurality of devices; and
determining, based on the power condition data and the number of charge cycles, the second device to wirelessly provide power to the first device.

16. The method of claim 12, wherein the state data comprises a dominant hand preference associated with a user indicating whether the user favors right-handed use or left-handed use, the method further comprising:
determining, based on the power condition data and the dominant hand preference, the second device to wirelessly provide power to the first device.

17. The method of claim 12, the method further comprising:
determining, based on the power condition data, a charge imbalance between the first device and at least one of the plurality of the devices; and
determining, based on the power condition data and the charge imbalance, the second device to wirelessly provide power to the first device.

18. One or more non-transitory computer-readable media storing instructions that, when executed by one or more processors, cause the one or more processors to perform operations comprising:
receiving power condition data representing power conditions associated with a plurality of devices;
determining, based on the power condition data, a first device of the plurality of the devices to wirelessly receive power from one or more of the plurality of the devices;
receiving state data associated with the plurality of devices;
determining, based on the power condition data and the state data, a second device of the plurality of the devices, wherein the second device is configured to wirelessly provide power to the first device;
generating a power distribution command configured to cause wireless power transmission from the second device to the first device; and
sending the power distribution command to at least one of the first device or the second device to initiate wireless power transmission from the second device to the first device.

19. The one or more non-transitory computer-readable media of claim 18, wherein the state data comprises at least one of:
location data associated with the plurality of devices,
application data including an indication of a running application associated with the plurality of devices,
activity data indicating a current or predicted activity level associated with the plurality of devices,
preference data indicating a dominant hand preference associated with a user indicating whether the user favors right-handed use or left-handed use, or
charge cycle data indicating a number of charge cycles associated with the plurality of devices, and
wherein determining the second device to wirelessly provide power to the first device is further based on the at least one of the location data, the application data, the activity data, the preference data, or the charge cycle data.

20. The one or more non-transitory computer-readable media of claim 18, the operations further comprise:
determining, based on the power condition data, a charge imbalance between the first device and at least one of the plurality of the devices; and
determining, based on the power condition data and the charge imbalance, the second device to wirelessly provide power to the first device.
